(19) United States
(12) Patent Application Publication
(10) Pub. No.: US 2018/0189454 A1
(43) Pub. Date: Jul. 5, 2018

(54) HEALTH AND WELLNESS SYSTEM

(71) Applicant: Taylor Breanne Johnson, Southport (AU)

(72) Inventor: Taylor Breanne Johnson, Southport (AU)

(21) Appl. No.: 15/393,791

(22) Filed: Dec. 29, 2016

(51) Int. Cl. G06F 19/00; G06Q 10/10

(52) U.S. Cl. CPC G06F 19/3418; G06Q 10/1093

(57) ABSTRACT

A health and wellness method comprises the steps of geolocating one or more devices that are in communication with one or more users. A user is either a seeker or a provider. The seekers generate a request to one or more servers wherein the request is transmitted to a network. A list of providers is generated by at least proximity, a rating, and availability of the one or more providers. Providers input availability into a network integrated calendar. Seekers rate the provider from parameters consisting of booking history, cancellation history, and average rating. An accolade system comprises rating on or more providers. Ratings are stored in a server, and displayed on the device. Seekers are rated and displayed on the device. A rating threshold is specified, ratings above the threshold receive an accolade.

### BACKGROUND OF THE INVENTION

### 1. Field of Invention

The present invention relates to the field of health and wellbeing and in particular, methods and systems that connect a person seeking wellness to experts who provide wellness services.

### 2. Description of Related Art

Health and wellbeing affects every person around the globe. Increasing knowledge, technology and education brings services and information about our health to the individual more frequently now than ever before. The fusion of different ways to maintain a healthy lifestyle is more prevalent now than ever before as we learn and adopt wellness practices from diverse professions and cultures.

Health and wellbeing is not confined to physical health. There are multiple aspects that contribute to the wellbeing of an individual. Increasingly health professionals are gearing towards a holistic approach when looking to improve or maintain and individual's health or wellness. No longer do we only seek the advice of a traditional medical doctor. To name a few examples, consumer's reach out to fitness and exercise experts, psychological and motivational experts, spiritual and religious practitioners, and combinations of these professions, in an effort to seek wellness and longevity in building quality of life.

Individuals are empowered with knowledge and a plethora of services to address different aspects of health. Physical, emotional, motivational, spiritual, and even financial aspects are all some of the areas a consumer will look to in improving their health and wellness.

When a person is seeking to improve their health or wellness, often they will conduct a traditional Internet or other search to see what they will find. This type of searching is manual, very time consuming and may not actively connect a person to professional or yield the type of results they are seeking.

Therefore, there is a need in the art for providing a one-stop shop for consumers who want to improve their fitness, health and wellness in connecting these consumers with health or wellness professionals.

### SUMMARY OF THE INVENTION

A health and wellness system comprises the steps of geolocating one or more devices that are in communication with one or more users. A user is either one or more seekers or one or more providers. The seekers generate a request to one or more servers wherein the request is transmitted to a network. A list of providers is then generated by the parameters of proximity, a rating, and an availability of the providers.

Providers input availability into a network integrated calendar. Providers are displayed to the seekers in order of rating, proximity, and availability. Ratings are input by the one or more seekers. Seekers use the parameters of booking history, cancellation history, and quality of service to rate the providers.

An accolade system comprises rating one or more providers, ratings of the one or more providers are stored in the server and displayed on the devices in the network. Further, ratings of the one or more seekers are stored in the server and displayed on the devices in the network.

A ratings threshold is specified wherein ratings above the threshold receive and accolade. The accolade is then stored in the server and displayed on the devices.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the method, according to an embodiment of the present invention;

FIG. 2 is a flowchart of the method, according to an embodiment of the present invention;

FIG. 3 is a flowchart of the method, according to an embodiment of the present invention; and

FIG. 4 is a flowchart of the method, according to an embodiment of the present invention.

### DETAILED DESCRIPTION OF PREFERRED EMBODIMENTS

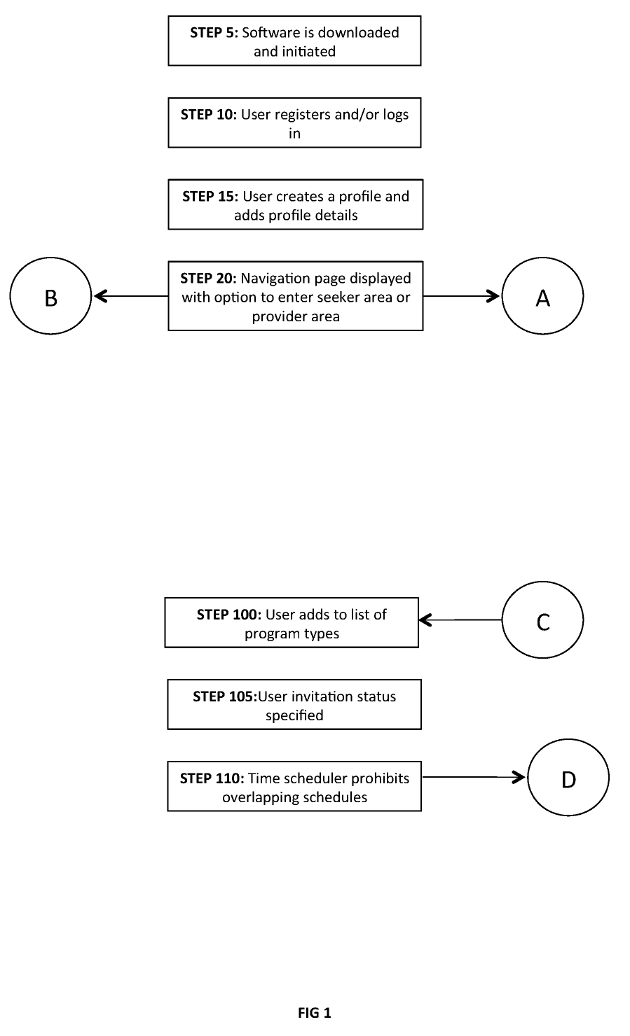

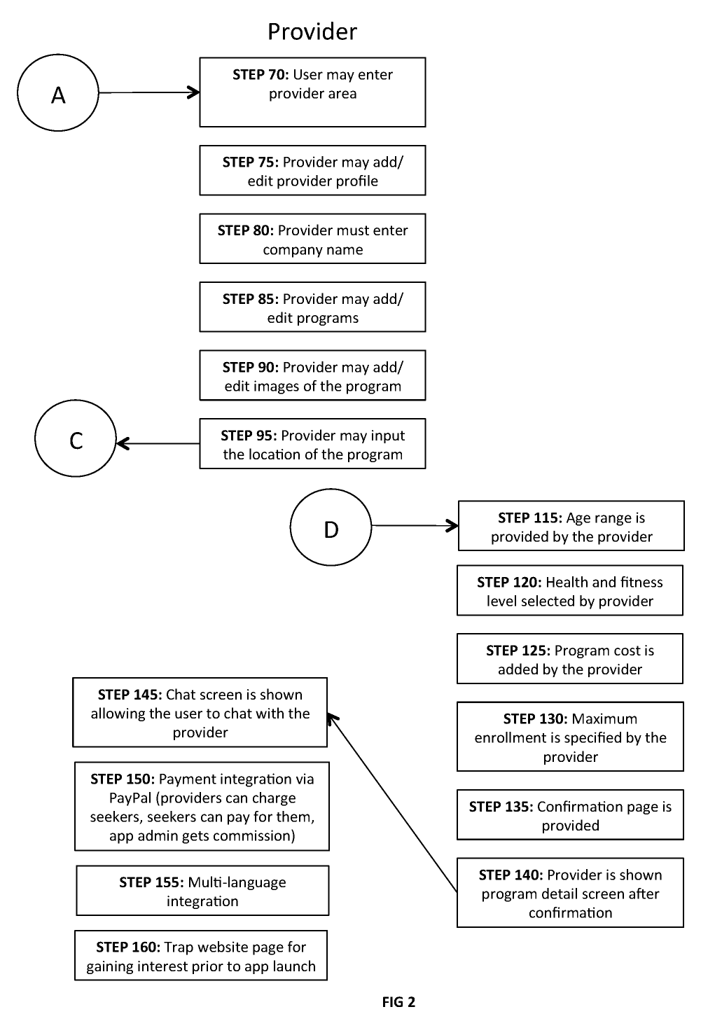

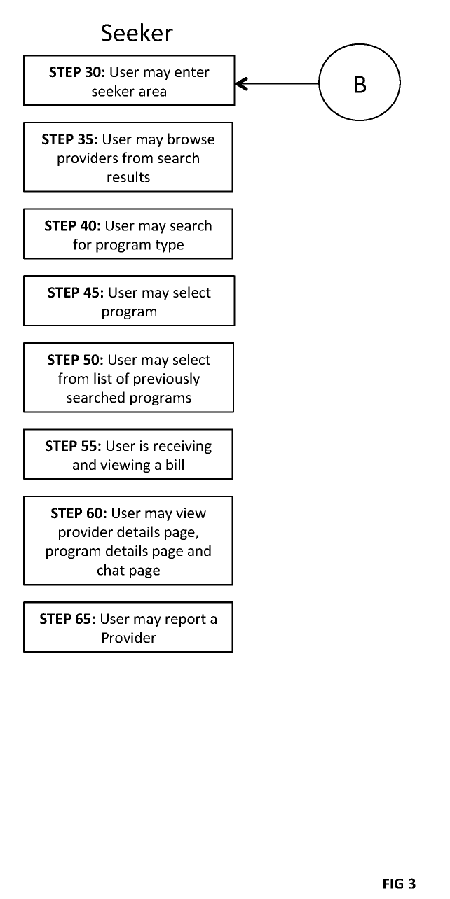

Preferred embodiments of the present invention and their advantages may be understood by referring to FIGS. 1-4, wherein like reference numerals refer to like elements.

In one embodiment, the system is a software application that resides on a mobile device. In another embodiment, the system is network connected, on a website or web app for example, to enable convenient use by users.

In an embodiment, the seeker is a customer seeking to improve their overall wellbeing in seeking a holistic approach to their health care.

In an embodiment, the system interacts with a provider's existing business system to provide an expedited and relevant communication platform between the customer or seeker and the business or service provider.

In an embodiment, the provider is a health care professional such as a doctor, personal trainer, yoga instructor, masseuse, or other form of professional.

In particular embodiments, the system interacts with a seeker or user by receiving data input from the user or seeker or other entity about the seeker's or user's personal features. Personal features comprise but are not limited to data as health parameters, medical test results, scan results, physical features for example body type, photographs, psychological indicators or assessments, spending habits, disabilities, strength ability, bodily or other injuries, allergies, food preference, taste preference, and physical activity preference. In particular embodiments, the data input is entered by the seeker, analyzed by the processor, received and considered by the providers or the providers business system, returned to the seeker for further input or additional or different data input than originally processed. The system can continue to repeat until the seeker or provider chooses to end communication. In a particular embodiment, a live-stream feature is available allowing personal trainers, motivational coaches, nutritionists, and other members of the community to work with clients from the comfort of their own homes or office.

In an embodiment, the seeker will decide to engage in a healthcare service, for example, the seeker may want a massage at 4 PM the next day. Having the application downloaded onto a mobile device or desktop computer, the user may search for a masseuse in a location of their choice. The seeker may also have the option to search a nearby masseuse. Results for the search will be listed along with availability of each of the results listed. Numerous results may be listed according to relevancy, newest listing, or proximity to the seeker, among other tools known in the art.

In an embodiment, the user may select a listing to view or relevant provider profiles. Provider profiles may include but are not limited to; availability calendars, photos, bios, ratings, reviews, and accolades.

In a preferred embodiment, a “SUPER FOCUSED” accolade is given to both seekers and providers whom meet certain desirable criteria. For example, a seeker may earn the “SUPER FOCUSED” accolade by booking history, cancellation history, and number of positive reviews from other members. In an embodiment, a provider may earn the “SUPER FOCUSED” by booking history, cancellation history, and reviews from other members.

In a preferred embodiment, for example, a seeker may qualify as “SUPER FOCUSED” by making 10 bookings, having no cancellations, and having 5 4-5 star reviews. Further, a provider may acquire the accolade under the same parameters, as would a seeker. Badges are earned upon receiving the “SUPER FOCUSED” accolade. The badge is displayed on the users profile, as well as on the listing so that other users are aware of the SUPER FOCUSED status of the user.

In the event that a seeker or provider does not meet acceptable service standards, receives an excess number of complaints, or falls below a certain star threshold, the seeker or provider may be terminated from the program. In an embodiment, users may report other users whom they did not receive a pleasant experience with. This information is relayed to a RESOLUTION CENTER, wherein moderators of the software are able to review each complaint and make a determination to terminate the user or not. Actions taken may include suspending an account for a specified time, or resolving a solution.

In an embodiment, a provider may choose to engage in the services of the application. A provider may create a listing for their service. The provider may list pricing and any fees associated with the service.

In a preferred embodiment, the provider may edit a calendar based on availability. The calendar may reflect pricing on specific days and may update pricing as demand and availability increase or decrease. The calendar provided by the seeker may interact with the user by suggesting less expensive days, or providing open availability time slots. Further, the calendar may communicate with the user and provider by receiving inquiries.

In an embodiment, the provider receives inquiries sent by a seeker. The provider is then allowed the option of accepting or confirming a booking based on the inquiry sent by a user. In an embodiment, the calendar is automatically updated based off information sent once the provider selects to either book a seeker, or change availability.

In a preferred embodiment, a provider is able to chat with a seeker in order to discuss details of the inquiry, confirm booking, or provide further information.

In a preferred embodiment, payments are transmitted through the app. In an embodiment, an online payment system is integrated into the application. In an embodiment, the application tracks the end-time of booking in order to require payment at a specific time.

In an embodiment, a provider offers an “INSTANT BOOKING” feature. In this embodiment, the user can automatically book a provider based on availability of the provider. In order to ensure fidelity of the listing, the provider must have their listing approved before posting the listing for the first time. This feature is integrated with the calendar of availability to ensure that the instant booking feature does not overbook the provider.

In an embodiment, a registration system provides seekers with a list of services which are available at a time specified by the user, coinciding with a day and time available provided by the provider. The registration system is able to record any interaction between the seeker and the provider. In an embodiment, the seeker is able to view metrics provided by the system regarding the provider. In example, the seeker can see the “SUPER FOCUSED” accolade of the provider. Seekers can also view an average response time, as well as other metrics.

A referral program allows users, both seekers and providers, to invite others into the network. To accomplish this, a specific code is given to each user which they can give to new users. Upon entering the code when the new user signs up for the application, the user whom the code belongs to will receive credits within the application.

### Method

In an embodiment, in describing the user interface to the system, and with reference to FIGS. 1-3, at step 5 the user is initiating the download of software. At step 10 the user has an opportunity to signing up to the system and creating a personal profile where the user is inputting personal information including information about physical fitness programs or health services that the user is interested in. In an embodiment, the user can create a profile before being required to register or sign up. In an embodiment, at step 20, if a user has already created a profile and signed up, the user is given the option to be logging into the system. If the user has not created a profile, there is an option of going back to 15 and creating a profile.

In an embodiment, at step 15 the user is inputting various information relating to their personal information and to wellness and health. In an embodiment, the user is inputting data that is a mandatory or optional entry, wherein data inputted by the user includes, but is not limited to one or more but at least of the following: a profile image, name, gender, age, height, weight, body type, health history, medical history, exercise history, current exercise activities and frequencies, lifestyle activities. In an embodiment, the user is inputting data relating to health and wellbeing goals. In an embodiment, the personal data inputted by the user is determined by the health and wellness goals identified by the user. In an embodiment, data and reports are downloading into the user's profile from an external system such as from a health care facility, fitness coach, dietician or other health and wellness provider. In an embodiment, data and reports are uploading from the user's profile to an external system such as from a health care facility, fitness coach, dietician or other health and wellness provider. In an embodiment, data or analyzed data or both located in the user's profile is communicated with a provider, external system. In an embodiment, a provider uses the data to customize a wellness plan for the user. In an embodiment, the provider uses a plurality of users' data to determine what type of programs they should implement for a particular area of wellness.

In an embodiment, the user is recording experience or thought entries into a log located in the system. The user is inputting the recorded messages into their profile. In an embodiment, the system is analyzing the recording for trigger words and tonal fluctuations. The system generates a risk scale based on the analysis and sends a report to a provider. The provider is accessing the vocal log of the user and is analyzing the content and tone of the user's voice and words to contribute to a wellbeing and health assessment. The provider is forwarding the information to required authorities or insurance providers. Authorities and insurance providers are contacting the user for assistance measures.

In an embodiment, the user is inputting an image of their body or body part or both into their profile. In an embodiment, the user is recording an activity or movement and is uploading the data into the system. In an embodiment, the system analyzes data submitted by the user. The system may transmit data to the provider.

In an embodiment, the system populates the various indicators to develop a program based on the users reports and wellness goals.

At step 20, once authenticated by logging in, a user is navigating between a seeker area and a provider area. The seeker area is for users who looking for particular health and wellbeing goods and services and the provider area is for users who offer health and wellbeing goods and services. At step 30, a user is entering and accessing the seeker area of the system. At step 70 a user is entering and accessing the provider area of the system. In an embodiment, a user can be both a seeker and a provider, and in other embodiments, the user is one or the other.

At step 30, after a user has entered into the seeker area, the seeker is viewing a seeker home screen. In an embodiment, at step 35, the seeker home screen is displaying a list of programs that the seeker has previously shown interest or saved, requested and received invitation requested from providers, and program types. In an embodiment, at step 40 the seeker home screen is displaying a search option where the seeker is searching programs and program types. There is a configure search button that helps the user to search for programs. On selecting the search button, there appears a list of types of programs that the user can choose to search. Programs can include categories and types such as, but not limited to; fitness, bodybuilding, yoga, meditation, aerobics, and martial arts. In an embodiment, the seeker is able to select search preferences that limit the results of the search and listed programs and program types based on the seekers preferences. The seekers preferences include, but are not limited to, preferred time period, preferred location, and cost. The user is able to refresh the seeker home screen at any time when connected to the internet so that any new programs offered are able to be synced in real time with the system.

In an embodiment, at step 45, the seeker selects a program and on selection the system is directed to a program detail page. At the program details page, the system is displaying the particular details about a program offered by a provider. In an embodiment, goods and services that relate to the program and other, directly or indirectly, related programs are included in the program detail page. In an embodiment, the program detail page includes information such as program name, program type details, program description, program location, provider's name, and a button to display the provider's details.

In an embodiment, at step 50, a seeker is sending a request for invitation to a selected program from the current page. Upon selecting to send a request for invitation, the system checks whether or not the user profile details are submitted. If a profile has not been submitted by the user, or there are insufficient number of predetermined fields completed, then the user is prompted to enter into the submit profile screens to collect the user's profile information.

In an embodiment, at step 55, a seeker is receiving and viewing a bill that has been sent by a provider from a particular program. In an embodiment, the seeker elected to have a bill sent to them and in another embodiment, the provider has sent out a promotional offer that the seeker can accept. In an embodiment, a button is shown in this page that has a label of the amount a user is required to pay for the program. In an embodiment, upon selecting the button that displays the bill amount, the seeker is directed to an external service provider, such as PayPal, in order to process the payment.

In an embodiment, at step 60 a seeker has already sent out a request for invitation as at step 50, and the provider has accepted the request for invitation. There is a button where the user can choose to go into a chat screen in order to communicate with the provider, who has accepted the invitation. If an invitation has not been requested by the seeker, the seeker is redirected to request an invitation. If a provider has not yet accepted an invitation, the seeker will need to wait for the invitation to be accepted before they can initiate a chat session with the provider. Alternatively, at step 65 a seeker is provided with alternative means of contacting the provider as outlined in the provider details page. The buttons may be hidden or in shadow depending on the options that are available.

In an embodiment, at step 70, a user can navigate a home screen to enter into a provider area of the system, separate from the seeker area. In an embodiment, by default the provider area starts with the Provider home screen. On loading for the first time, the provider details are collected. Add/edit provider screen is provided to collect the provider's details. In an embodiment, the screen components include but are not limited to collecting the providers logo/Image, provider name, provider country, provider address, provider contact number, email address, provider description. The provider is required to upload company details in order to be able to load program details at a later stage. If the provider does not provide details at this step they will have the opportunity to come back to this step at a later step when they attempt to enter a program and services into the system.

In an embodiment, at step 75, the system is providing a list of programs available to the user. In an embodiment, the list of programs that appear have been previously added by the provider. In an embodiment, the system extracts programs that already exist in the providers business by synchronizing with the provider's system. Alternatively, a user can manually upload the program details into the system. A user has the option to add new programs, edit existing programs, and connect and link programs that they provide.

In an embodiment, at step 80, a provider is required to register their company first, before adding program details. If company details are not entered, the provider has to go through the step of adding the relevant company details before they are permitted to add a program. In an embodiment, the details are verified before the company is approved.

In an embodiment, at step 85, the provider can add their programs. During the process of adding programs, the provider has the option to navigate between various pages including going back to a previous page or move forward to a next page. In order to add a program the provider is required to go through multiple steps in providing certain information and entering and uploading certain data and documents. The provider is required to provide a program name as a mandatory field on the add program page. In an embodiment, in step 90 the provider uploads images of the program that can be representative images or actual images. On each image there is an option to remove each image. A minimum of one image is required for each added program. The provider has the option to go back to a previous page or move forward to a next page. In step 95 the provider may upload the location of the program, which may interface with a map function to show the location in the context of the user's location, for example. In step 100 the user may add the program type, whether fitness, bodybuilding, yoga, martial arts, aerobics, or other similar types. The user has an option to add a new type and use that for the program. In step 105 invitation status may be specified, wherein the program may be open or by invitation or pre-approval only. This may be particularly relevant where there is a limited enrolment or a prerequisite ability level. In step 110, a time scheduling function permits entry of times surrounding the program, including program time, and preparation time. Also, a time may be entered past which late arrivals may not join (for example yoga programs may be disrupted by late arrivals).

In step 115, the age range for the program is provided by the provider, whether a range or an age category (baby, child, teenager, adult or elderly, etc.) In step 120, a health condition or fitness level (specific or general, such as out-of-shape, about average, athletic or elite) is selected by the provider, and the program may be restricted to certain fitness levels so that people signing up to the class may feel at ease, for example in a non-competitive environment.

Is step 125, a program cost is added by the provider, and in step 130 the maximum number of participants or enrolment may be specified.

In step 135, a confirmation page is provided, wherein the enrollment information filled by the provider is summarized for review before submission. There is an edit button that permits the provider to move back into an earlier screen for editing the information. In step 140, the provider is shown the Program Detail screen once the confirmation, in step 135, is agreed to, and the program detail screen contains the program information, the request for invitations that have been received and the invitations have been sent out, and a list of current participants. On each participant, there is a cancel invitation button, wherein a host may remove a participant from a program. A button to change invitation status is required (if there is at least one participant there will be a status close, meaning no more invitations are provided). There is a button to show a list of invitation requests, and when one is selected a pop up window may be shown which enables the provider to accept or reject the requests.

In step 145, a chat screen is shown wherein the user may chat with the provider regarding the program. In step 150, the user may be shown a billing screen, wherein the program name and type are shown, along with the bill amount.

In an embodiment, payments from user are kept in escrow until provider has rendered service satisfactorily. Further, the programs may receive a rating. To make it easy to rate, will have classifications for rating (eg: Knowledgeable, on time, helpful, flexible/accommodative of time, etc.) What others also bought may be shared on social media, for example, as a recommendation to users of other services/products that other users have purchased when they bought this particular item from a provider. Group classes may be permitted for seekers, and classes may have a minimum number of bookings needed to start, and have a maximum number of participants that may be accommodated, and the class may be cancelled by a provider. In one embodiment, the providers calendar may be seen by the users to find when programs are available. Providers can mark classes outside of the focus of the app as ‘blocked/not available’. Push notifications from calendar may be used to remind users that the next class they have booked is due.

In an embodiment, at step 155 the system included multi-language integration. Further, a trap website may be created at step 160 in order to generate interest prior to launch of the application.

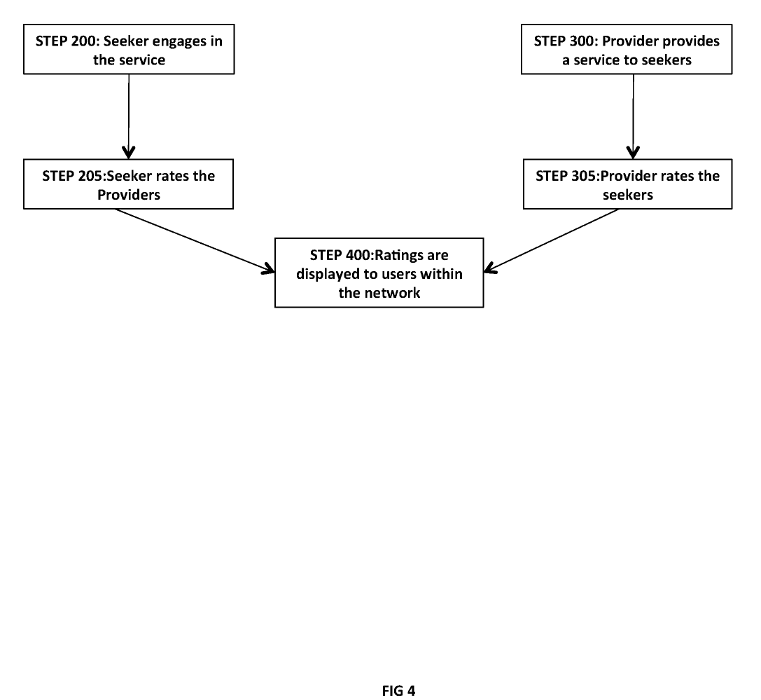

In reference to FIG. 4, seekers and provider rate one another based on their experience in providing a service to the seeker, or experiencing the service provided by the provider. In Step 200, a seeker engages in a service. Depending on parameters such as; whether or not the provider cancels the scheduled service, changes terms of the service, number of successful bookings in the history of the providers use of the application, and general quality of service, the user will rate the provider from one to five stars in step 205. In Step 300, a provider provides a service to the user. Afterwards the provider then rates a seeker depending on parameters such as; whether or not the seeker cancels the scheduled service, changes terms of the service, number of successful bookings in the history of the seekers use of the application, and general quality of the interaction with the seeker. This action comprises step 305. In step 400 ratings by both the seekers and providers are transmitted to the network, this data is then transmitted to the one or more servers and to the one or more devices where the ratings are viewable by each user.

In an embodiment, the software is downloaded into a mobile device or computer. The system has a memory element, processor, wireless receiver and transmitter. In particular embodiments, the system has sensors, voice and image recorders, and tone analyzers. The user is using the devices to record particular aspects of their health and wellbeing and then uploading the detected data from the device into the storage element.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A health and wellness method comprising the steps of:
a. geolocating one or more devices, wherein each of the one or more devices is in communication with two or more users, wherein at least one of the users is a seeker, wherein at least one of the users is a provider;
b. the at least one seeker generating a request to one or more servers, wherein the request is transmitted to a network; and
c. generating a list of providers wherein the list is generated by at least a proximity, a rating, and an availability of the one or more providers.

2. The method of claim 1, wherein the one or more providers input availability into a network integrated calendar.

3. The method of claim 2, wherein the availability is stored in the server, wherein the server is in communication with the network.

4. The method of claim 3, wherein the one or more providers are displayed in order of proximity to the one or more seekers.

5. The method of claim 4, wherein the one or more providers are displayed in order of a rating.

6. The method of claim 5, wherein one or more seekers input the rating of the one or more providers.

7. The method of claim 6, wherein the one or more seekers rate the one or more providers from a plurality of parameters selected from a group consisting of; a booking history, a cancellation history, and a quality of service.

8. The method of claim 1, wherein the rating of the one or more providers are displayed on the devices of the one or more users.

9. The method of claim 1, wherein the one or more providers rate the one or more seekers from a plurality of parameters selected from a group consisting of; booking history, cancellation history, and average rating.

10. The method of claim 1, having an accolade system comprising:
a. rating one or more providers, wherein ratings of the one or more providers are stored in the server, wherein ratings of the one or more providers are displayed on the device;
b. rating one or more seekers, wherein ratings of the one or more seekers are stored in the server, wherein ratings of the one or more seekers are displayed on the device; and
c. specifying a rating threshold, wherein ratings above the threshold receive an accolade.

11. The method of claim 10, wherein the ratings stored in the server are transmitted to a network.

12. The method of claim 10, wherein the accolade system further comprises a ratings threshold, wherein having a rating above the threshold grants the user an accolade, wherein the accolade is stored in the server, wherein the accolade is displayed on the device.
